(19) United States
(12) Patent Application Publication
(10) Pub. No.: US 2026/0280996 A1
(43) Pub. Date: Sep. 17, 2026

(54) METHOD AND APPARATUS FOR REQUESTING ANALYTICS DATA IN WIRELESS COMMUNICATION NETWORK

(71) Applicant: Samsung Electronics Co., Ltd., Gyeonggi-do (KR)

(72) Inventors: Sapan Pramodkumar SHAH, Bangalore (IN); Narendranath Durga TANGUDU, Bangalore (IN)

(21) Appl. No.: 19/167,430

(22) PCT Filed: Mar. 22, 2024
(86) PCT No.: PCT/KR2024/003612

§ 371 Date: Sep. 22, 2025

(30) Foreign Application Priority Data
Mar. 22, 2023 (IN) 202341020163
Mar. 7, 2024 (IN) 202341020163

(51) Int. Cl. H04L 41/14; H04L 9/32

(52) U.S. Cl. CPC H04L 41/145; H04L 9/321

(57) ABSTRACT

The disclosure relates to a 5G or 6G communication system for supporting a higher data transmission rate. Embodiments herein disclose methods and apparatus for requesting analytics data in a wireless communication network. The method comprises transmitting, by an analytics consumer entity, to a first analytics provider entity, a discovery request message comprising information to be used to get load analytics information from at least one ADAE server, and receiving, by the analytics consumer entity, a discovery response message corresponding to the discovery request message, from the first analytics provider entity, wherein the discovery response message comprises information of one or more discovered AS entities and analytics information corresponding to the one or more discovered AS entities.

### TECHNICAL FIELD

Embodiments disclosed herein relate to wireless communication networks, and more particularly to methods and systems for requesting analytics data by facilitating discovery and selection of one or more Application servers (ASs) in a wireless communication network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In TS 23.558Rel-17, 3GPP has defined Edge Enabler Layer (EEL). The EEL exposes APIs to support capabilities such as, but not limited to, service provisioning, registration, application server discovery, capability exposure to AS and support for service continuity. The Application Clients (ACs) in the User Equipment (UE) can locate and connect with a most suitable Edge Application Server (EAS) available in the Edge Data Network (EDN), using the capabilities provided by the EEL. For application server discovery capability, the Edge Enabler Server (EES) provides EAS discovery functionality to the EEC to allow the AC in the UE to discover appropriate application servers. However, in certain scenarios, the EEC may want to select the best EAS based on criteria such as, but not limited to, performance, load statistics, computation resource usage etc. Currently, such information is not available to the EEC, so the EEC is unable to choose the best EAS based on criteria related to load and performance. The application server discovery capability can be improved to provide statistical and predictive analytics about the discovered EASs which will enable the EEC or EES to select the best EAS among the available EASs.

3GPP specified Edge load analytics service provides insights on the operation and performance of an EDN and statistics or prediction on parameters related to the EAS/EES load level of edge computational resources and other performance parameters.

Such analytics can be used to improve the edge services, like allowing the consumer of the application server to select a server from the group of application servers, which it wants to receive services based on the available analytics data (statistical and predictive) of the application server; for example, load analytics data, performance analytics data, and like so.

As of now, no method exists in the 3GPP standards to allow UE or clients on the UE to request analytics of the EAS in order to select appropriate EAS.

Hence, there is a need in the art for solutions which will overcome the above mentioned drawback(s), among others.

### DISCLOSURE OF INVENTION

### Technical Problem

The principal object of the embodiments herein is to disclose methods and systems to improve at least one Application server (AS) discovery and Application server (AS) selection using load analytics of one or more discovered AS.

Another object of the embodiments herein is to disclose methods and systems for enabling at least one analytics consumer entity to request to at least one first analytics provider entity, analytics information of the at least one discovered Application Server (AS) and to select the best available AS, based on analytics information of one or more ASs.

Another object of the embodiments herein is to disclose methods and systems for requesting at least one second analytics provider entity by the at least one first analytics provider entity, for receiving analytics information for one or more ASs, wherein the one or more application servers (ASs) are identified by the at least one first analytics provider entity, based on the at least one AS discovery message request of the at least one analytics consumer entity.

Yet, another object of embodiments herein is to disclose methods and systems for enabling the at least one analytics consumer entity to transmit a filtered AS discovery request message to the at least one first analytics provider entity, wherein the filtered AS discovery request message comprises an indication of at least a minimum required load analytics data and at least an expected load analytics data.

### Solution to Problem

Accordingly, the embodiments herein provide methods for for requesting analytics data in a wireless communication network. The method comprises: transmitting, by an analytics consumer entity, to a first analytics provider entity, a discovery request message comprising information to be used to get load analytics information from at least one application data analytics enabler (ADAE) server, and receiving, by the analytics consumer entity, a discovery response message corresponding to the discovery request message, from the first analytics provider entity, wherein the discovery response message comprises information of one or more discovered application server (AS) entities and analytics information corresponding to the one or more discovered AS entities.

Accordingly, the embodiments herein provide methods for a method for requesting analytics data in a wireless communication network. The method comprises: receiving, by a first analytics provider entity, from a analytics consumer entity, a discovery request message to discover at least one application server (AS) entity, wherein the discovery request message comprises information to be used to get load analytics information from at least one application data analytics enabler (ADAE) server, transmitting, by the first analytics provider entity, to a second analytics provider entity, an analytics data request message to get analytics data for one or more discovered application server (AS) entities, identified by the first analytics provider entity based on the discovery request message of the analytics consumer entity, receiving, by the first analytics provider entity, from the second analytics provider entity, an analytics data response message comprising analytics information corresponding to the one or more discovered AS entities, and transmitting, by the first analytics provider entity, a discovery response message to the discovery request message as transmitted by the analytics consumer entity, wherein the discovery response message comprises information of the one or more discovered AS entities and the analytics information corresponding to the one or more discovered AS entities.

Accordingly, the embodiments herein provide an analytics consumer entity comprising, a processor, and memory communicably coupled with the processor. The processor is configured to: transmit a discovery request message to a first analytics provider entity, wherein the discovery request message comprises information to be used to get load analytics information from at least one application data analytics enabler (ADAE) server, and receive a discovery response message corresponding to the discovery request message, from the first analytics provider entity, wherein the discovery response message comprises information of one or more discovered application server (AS) entities and analytics information corresponding to the one or more discovered AS entities.

Accordingly, the embodiments herein provide a first analytics provider entity for requesting analytics data in a wireless communication network, comprising: a processor, and memory communicably coupled with the processor. The processor is configured to: receive a discovery request message to discover at least one application server (AS) entity from a analytics consumer entity, wherein the discovery request message comprises information to be used to get load analytics information from at least one application data analytics enabler (ADAE) server, transmit an analytics data request message, to a second analytics provider entity, to get analytics data for one or more discovered application server (AS) entities, identified by the first analytics provider entity, based on the discovery request message of the analytics consumer entity, receive, from the second analytics provider entity, an analytics data response message comprising analytics information corresponding to the one or more discovered AS entities, and transmit, to the analytics consumer entity, a discovery response message comprising information of the one or more discovered AS entities and the analytics information corresponding to the one or more discovered AS entities.

Accordingly, the embodiments herein provide methods for facilitating selection of at least one Application server (AS) entity, wherein the method comprises, transmitting, by at least one analytics consumer entity, to at least one first analytics provider entity, at least one AS discovery request message, wherein the at least one AS discovery request message comprises an indication for requesting load analytics information corresponding to at least one discovered AS entity. Further the method comprises receiving, by the at least one analytics consumer entity, at least one response message to the at least one AS discovery request, from the at least one first analytics provider entity, wherein the at least one response message comprises one or more discovered AS entities with load analytics information corresponding to the one or more discovered AS entities. The method further comprises selecting, by the at least one analytics consumer entity, at least one AS entity of interest from the list of the one or more discovered AS entities, based on the at least one response message.

Accordingly, the embodiments herein provide an analytics consumer entity comprising, at least one processor and a memory (112) communicably coupled with the at least one processor, wherein the at least one processor is configured to transmit, at least one AS discovery request message, wherein the at least one AS discovery request message comprises an indication for requesting load analytics information corresponding to at least one discovered AS entity. Further, the at least one processor of the analytics consumer entity is configured to receive, at least one response message corresponding to the at least one AS discovery request message, from at least one first analytics provider entity, wherein the at least one response message comprising one or more discovered AS entities with load analytics information corresponding to the one or more discovered AS entities. The processor of the analytics consumer entity further, is configured to select at least one AS entity of interest from the one or more discovered AS entities, based on the at least one response message.

Accordingly, the embodiments herein provide a first analytics provider entity comprising, at least one processor and a memory communicably coupled with the processor, wherein the processor is configured to receive, at least one AS discovery request message from at least one analytics consumer entity, wherein the at least one AS discovery request message comprises an indication for requesting load analytics information corresponding to at least one discovered AS entity. The processor of the first analytics provider entity is configured to facilitate, discovery of, one or more AS entities having load analytics information corresponding to the one or more AS entities as discovered. Further, the processor of the first analytics provider entity, is configured to generate, at least one response message comprising one or more discovered AS entities including the load analytics information corresponding to the one or more discovered AS entities.

Accordingly, the embodiments herein provide systems to improve server discovery and selection using analytics of the application server, wherein the systems allow at least one analytics consumer entity to request analytics of at least one Application server (AS) and enable selection of at least one AS of interest from one or more discovered ASs, based on the requested analytics.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 depicts a system (100) for facilitating one or more Application servers (ASs) discovery and selection of at least one AS based on analytics information of one or more discovered ASs, in a wireless network, according to various embodiments as disclosed herein;

FIG. 2 depicts a flow chart depicting the process (200) for facilitating selection of at least one Application server (AS), based on load analytics information corresponding to one or more discovered ASs, according to various embodiments as disclosed herein;

FIG. 3 depicts a method (300) for selecting by the at least one analytics consumer entity at least one Application server (AS) of interest, based on at least one AS discovery request, according to various embodiments as disclosed herein;

FIG. 4 depicts a method (400) for receiving by at least one first analytics provider entity load analytics information of one or more ASs from at least one second analytics provider entity, according to various embodiments as disclosed herein; and

FIG. 5 depicts a method (500) for providing by the at least one analytics consumer entity one or more discovery filters in the at least one AS discovery request, for the at least one first analytics provider entity, according to various embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

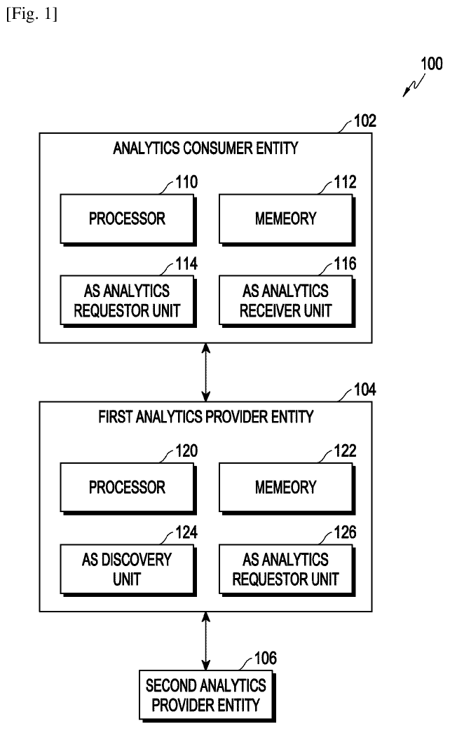

The embodiments herein achieve methods and systems to facilitate application server (AS) discovery and selection based on analytics of the AS. Referring now to the drawings, and more particularly to FIGS. 1 through 5, where similar reference characters denote corresponding features consistently throughout the figures, there are shown at least one embodiment. In this specification “Application server (AS)” and “Application server (AS) entity” are used interchangeably. Further, “Application servers (ASs)” and “Application server (AS) entities are used interchangeably”.

FIG. 1 depicts the system (100) for facilitating one or more Application servers (ASs) discovery and selection of at least one AS based on analytics information of one or more discovered ASs, in a wireless network, according to various embodiments as disclosed herein. In an embodiment, the at least one AS can be at least one Edge Application server (EAS) for which load analytics information is requested. The system comprises at least one analytics consumer entity (102), at least one first analytics provider entity (104), and at least one second analytics provider entity (106).

The wireless network can be, for example, but not limited to a fourth generation (4G) network, a fifth generation (5G) network, a 6G network, an Open Radio Access Network (ORAN) or the like. In an example embodiment herein, the system (1000) can further comprise a plurality of network units distributed over a geographic region. In an example embodiment herein, the plurality of network units can be referred to and/or can include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3 GPP gateway function (“TNGF”), an application function, a service enabler architecture layer (“SEAL”) function, a vertical application enabler server, an edge enabler server, an edge configuration server, a mobile edge computing platform function, a mobile edge computing application, a middleware entity, and so on.

Further, in an embodiment, the system (1000) is complaint with NR protocols standardized in third generation partnership project. The network units of the system (1000) are generally part of a radio access network that includes one or more con-trollers communicably coupled to one or more corresponding network units. The radio access network is generally communicably coupled to one or more core networks, which may be coupled to other networks, like the Internet and public switched telephone networks, among other networks.

Examples of the at least one analytics consumer entity (102) can be a stationary device, and/or a mobile device. Further, the at least analytics consumer entity can be an edge device such as but not limited to a network access device, a router, a routing switch, an integrated access device, and so on. The edge device may be a device that provides access to an enterprise or service provider core networks. In further examples, the device can be referred as a user equipment (UE), wherein the UE may be such as without limitation a user device, a cellular phone, a smartphone, a personal digital assistant (PDA), a wireless communication device, a desktop computer, a notebook, a Device-to-Device (D2D) device, a vehicle to everything (V2X) device, a foldable phone, a smart TV, an immersive device, and an internet of things (IOT) device, a handheld device, a tablet computer, a laptop computer, a cordless phone, a display device (e.g., monitors), and any other device capable of using the wireless network, so on.

Further, the at least one analytics consumer entity can be such as, but not limited to, a mobile station, a subscriber station, a mobile unit, a subscriber unit, an access terminal, a mobile terminal, a wireless terminal, a remote terminal, a handset, a user agent, a mobile client, a client, and so on. In some cases, at least one analytics consumer entity can be able to communicate directly with another device (e.g., using a peer-to-peer (P2P) or device-to-device (D2D) protocol and so on).

The at least one analytics consumer entity (102) can comprise a processor (110), a memory (112), an AS analytics requestor unit (114), and an AS analytics receiver unit (116).

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (112).

The processor (110) is configured to execute instructions stored in the memory (112) and to perform various processes. The at least one analytics consumer entity (102) further comprises a communicator (not shown in FIG. 1). The communicator is configured for communicating internally between internal hardware components and with external devices via one or more networks. The memory (112) also stores instructions to be executed by the processor (110). The memory (112) may include non-volatile storage elements.

Examples of such non-volatile storage elements may include magnetic hard discs, optical discs, floppy discs, flash memories, or forms of electrically programmable memories (EPROM) or electrically erasable and programmable (EEPROM) memories. In addition, the memory (112) may, in some examples, be considered a non-transitory storage medium. The term “non-transitory” may indicate that the storage medium is not embodied in a carrier wave or a propagated signal. However, the term “non-transitory” should not be interpreted that the memory (112) is non-movable. In certain examples, a non-transitory storage medium may store data that can, over time, change (e.g., in Random Access Memory (RAM) or cache).

In an embodiment, the communicator includes an electronic circuit specific to a standard that enables wired or wireless communication. The communicator is configured to communicate internally between internal hardware components of the at least one analytics consumer entity (102) and with external devices via one or more networks.

The AS analytics requestor unit (114) may transmit an AS discovery request message to the first analytics provider entity (104), wherein the AS discovery request message can be for discovering at least one AS with load analytics information. In an embodiment, the request message may comprise at least one of a query for at least one available AS, an identity of the at least one analytics consumer entity (102), security credential(s) for authorization and verification of the at least one analytics consumer entity (102) by the at least one analytics provider entity, or an indication to provide load analytics information comprising of statistical and predictive analytics data of at least one discovered AS.

In an embodiment herein, the statistical and predictive analytics data may include without limitation, at least one of number of available ASs to connect for a given area or time window, edge computational resource usage data, number of times the at least one analytics consumer entity has received expected performance from the at least one analytics provider entity, Edge data network (EDN) high load indication events, or probability of unavailability of the one or more ASs of request due to high load. In an embodiment, the at least one AS discovery request message may be transmitted via the communicator of the at least one analytics consumer entity (102).

In an embodiment herein, the AS analytics requestor unit (114) may be such as without limitation, an Edge Enabler Client in a UE, an Application client in a UE, a SEAL client, an ADAE (Application data analytics enabler) client, a V2X application enabler client, and so on in a wireless network, configured to transmit the at least one AS discovery request to the at least one first analytics provider entity (104).

The AS analytics receiver unit (106) may receive the at least one response message corresponding to the at least one AS discovery request from the at least one first analytics provider entity (104). The at least one response message comprises one or more discovered AS with respective load analytics information. Further, in an embodiment, the analytics information can include statistical and predictive analytics data of the one or more discovered ASs, based on the at least one AS discovery request message.

In an embodiment, the statistical and predictive analytics data can include without limitation, at least one of number of available ASs to connect for a given area or time window, edge computational resource usage data, number of times the at least one analytics consumer entity (102) has received expected performance from the at least one first analytics provider entity (104), Edge data network (EDN) high load indication events, or probability of unavailability of the one or more ASs of request due to high load. In an embodiment herein, the at least one analytics consumer entity (102) may store the analytics information as received through the AS analytics receiver unit (106) and perform at least one action (e.g., selection of application server) based on the received analytics information.

The first analytics provider entity (104) is configured to receive the at least one AS discovery request message from the at least one analytics consumer entity (102). The first analytics provider entity (104) comprises, a processor (120), a memory (122), an AS discovery unit (124), and an AS requestor unit (126).

The processor (120) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (120) may include multiple cores and is configured to execute the instructions stored in the memory (122).

The processor (120) is configured to execute instructions stored in the memory (122) and to perform various processes. The at least one first analytics provider entity (104) further comprises a communicator (not shown). The communicator is configured for communicating internally between internal hardware components and/or with external devices via one or more networks.

The memory (122) also stores instructions to be executed by the processor (120). The memory (122) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (122) may, in some examples, be considered a non-transitory storage medium. The term “non-transitory” may indicate that the storage medium is not embodied in a carrier wave or a propagated signal. However, the term “non-transitory” should not be interpreted that the memory (122) is non-movable. In certain examples, a non-transitory storage medium may store data that can, over time, change (e.g., in Random Access Memory (RAM) or cache).

Through the AS discovery unit (124), the first analytics provider entity (104) may discover one or more ASs with respective load analytics information. The first analytics provider entity (104) may generate at least one response message corresponding to the at least one AS discovery request and transmit the at least one response message to the at least one analytics consumer entity (102). In an embodiment herein, the response message includes one or more discovered ASs with respective analytics information on the statistical and predictive analytics data for the one or more discovered ASs.

In an embodiment herein, the statistical and predictive analytics data can include without limitation, at least one of number of available ASs to connect for a given area or time window, edge computational resource usage data, number of times the at least one analytics consumer entity (102) has received expected performance from the at least one first analytics provider entity (104), Edge data network (EDN) high load indication events, or probability of unavailability of the one or more ASs of request due to high load.

In an embodiment, the at least one first analytics provider entity (104) may further transmit through the AS analytics requestor unit (126), at least one request message to a second analytics provider entity (106) (such as an ADAE server), for one or more analytics information of one or more ASs, wherein the one or more ASs are identified by the at least one first analytics provider entity (104) based on the at least one AS discovery request message from the at least one analytics consumer entity (102).

In an embodiment herein, the at least one request message comprises at least one of identity of the one or more identified AS for which the one or more analytics information is requested, type (such as, statistical and/or predictive) of the one or more analytics information, time duration since when analytics data is required, or location of the at least one analytics consumer entity. The at least one second analytics provider entity (106) may transmit at least one response message to the at least one first analytics provider unit (104), wherein the response message comprises analytics information corresponding to one or more identified ASs for which the at least one analytics provider entity (102) transmits the at least one request message in order to receive the load analytics information.

In an embodiment herein, the AS discovery unit (124) of the at least one first analytics provider unit (104) may receive the response message from the at least one second analytics provider unit (106). In an example embodiment herein, the at least one analytics consumer entity (102) may receive from the at least one second analytics provider unit (106), the response message comprising analytics information of the one or more identified ASs. In an embodiment herein, if load analytics information is not available for all discovered application servers, and partial load analytics information is available, then the at least one second analytics provider entity (106) may add the partial available load analytics information in the response message to transmit to the at least one first analytics provider entity (104).

With respect to various embodiments herein, the at one first analytics provider entity (104) may be without limitation at least one of an Edge Enabler Server, an Edge Configuration Server, a SEAL server, a V2X application enabler server, an Unmanned Aerial Vehicle application enabler server, and so on other entity which collects analytics data of the application server.

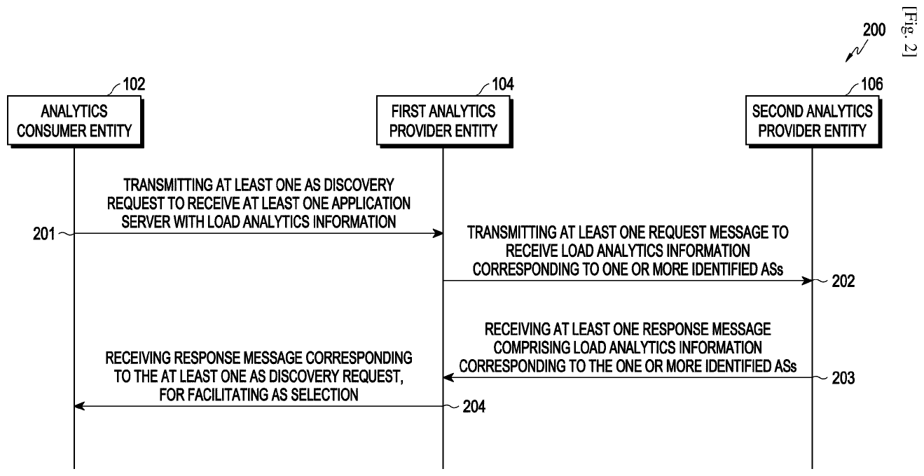

FIG. 2 depicts the flow chart depicting the process (200) for facilitating selection of at least one Application server (AS), based on load analytics information corresponding to one or more discovered ASs, according to various embodiments as disclosed herein. In an embodiment herein, the at least one AS and the one or more discovered ASs can be respectively at least one Edge enabler server (EAS) and one or more discovered Edge enabler servers (EASs).

Referring to FIG. 2, at step 201, at least one analytics consumer entity (102) may transmit at least one AS discovery request to at least one first analytics provider entity (104) in order to receive load analytics information for at least one application server (AS) from the at least one first analytics provider entity (104). In an embodiment, the request may be transmitted by way of at least one request message comprises at least one of an identity of the at least one analytics consumer entity, security credential(s) for authorization and verification by the at least one analytics provider entity, or an indication in the application discovery request message to provide the statistical and predictive analytics data of the discovered application servers (e.g., information to be used to get load analytics information from ADAES service (e.g., at least one second analytics provider entity). In an embodiment herein, the at least one AS discovery request may be transmitted through the at least one request message as transmitted by the at least one analytics consumer entity (102) via an AS analytics requestor unit (114).

In an example embodiment herein, the at least one first analytics provider entity (104) may collect load analytics data for one or more Application server(s) (ASs) that the at least one analytics consumer entity (102) can connect to and receive one or more services from the one or more ASs. Upon receiving the request, the at least one first analytics provider entity (104) may perform authentication of the at least one analytics consumer entity (102) based on the security credential(s) for authorization and verification as received from the at least one analytics consumer entity, subsequently authorizes the at least one analytics consumer entity to provide with one or more discovered ASs with respective load analytics information.

At step 202, the at least one first analytics service provider entity (104) may transmit a request message to at least one second analytics provider entity (106) for receiving load analytics information corresponding to one or more identified ASs, as listed out by the at least one first analytics service provider entity (104) based on the at least one AS discovery request message of the at least one analytics consumer entity (102). Upon receiving the at least one AS discovery message from the at least one analytics consumer entity (102), the at least one first analytics provider entity (104) may perform an AS discovery procedure (as described in 3GPP TS 23.558v18.3.0 ) to discover one or more ASs with load analytics information based on the at least one AS discovery request message from the at least one analytics consumer entity (102).

In an embodiment herein, if the load analytics information is not available at the at least one first analytics service provider entity (104), the at least one first analytics service provider entity (104) may transmit the request message for load analytics information to the at least one second analytics provider entity (106), for the one or more identified ASs. In an embodiment herein, the one or more identified ASs are obtained by the at least one at least one first analytics service provider entity (104), from the AS discovery procedure.

At step 203, the at least one second analytics consumer entity (106) may transmit at least one response message to the at least one first analytics provider entity (104), wherein the response message comprises analytics information corresponding to the one or more identified ASs. Upon, receiving the at least one response message, the at least one first analytics service provider entity (104) may transmit one or more discovered ASs with load analytics information as received from the at least one second analytics provider entity (106), to the at least one analytics consumer entity (102), wherein the one or more discovered ASs are selected from the one or more identified ASs for which the analytics information is requested to the at least one second analytics consumer entity (106).

At step 204, the at least one first analytics provider entity (104) may send at least one response message including load analytics information comprising statistical and predictive analytics data of the one or more discovered ASs, listed out from the one or more identified ASs based on the at least one AS discovery request message. Upon receiving the response message, the at least one analytics consumer entity (102) may store the load analytics information in the memory and perform at least one required action of selection of at least one AS of interest based on the received load analytics information.

In an embodiment herein, the load analytics information is, one or more statistical and predictive analytics data comprising at least one of: number of available ASs to connect for a given area or time window, edge computational resource usage data, number of times the at least one analytics consumer entity (102) has received expected performance from the at least one first analytics service provider entity (104), Edge data network (EDN) high load indication events, or probability of unavailability of the one or more ASs of request due to high load.

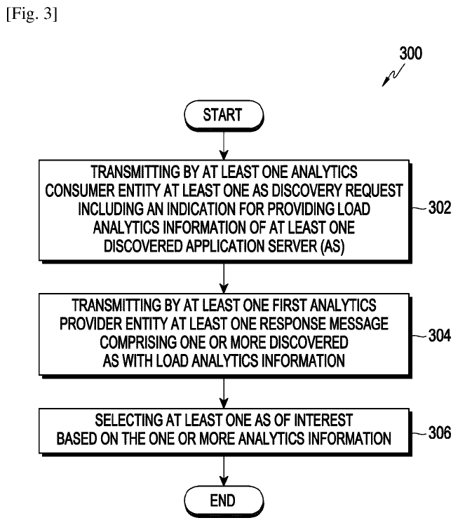

FIG. 3 depicts the method (300) for selecting by the at least one analytics consumer entity (102) at least one Application server (AS) of interest, based on at least one AS discovery request, according to various embodiments as disclosed herein. In an embodiment herein, the at least one AS of interest can be at least one Edge enabler server (EAS) of interest.

Referring to FIG. 3, at step 302, the method may comprise transmitting by at least one analytics consumer entity (102) at least one AS discovery request including an indication for providing load analytics information corresponding to at least one AS (e.g., information to be used to get load analytics information from at least one analytics provider entity), in order to enable selection of at least one best available application server, the at least one analytics consumer entity (102) can connect with. In an example embodiment herein, the analytics information may comprise at least one of number of available ASs to connect for a given area or time window, edge computational resource usage data, number of times the at least one analytic consumer entity (102) has received expected performance from the at least one first analytics provider entity (104), Edge data network (EDN) high load indication events, or probability of unavailability of the one or more ASs of request due to high load.

In an embodiment herein, the at least one AS discovery request may be transmitted through at least one AS discovery request message, to the at least one first analytics provider entity (104) via an AS analytics requestor unit (114). In an example embodiment herein, the at least one AS discovery request may comprise at least one of a query for at least one available AS, an identifier of the at least one analytics consumer entity (102), security credential(s) for authorization and verification of the at least one analytics consumer entity (102) by the at least one analytics provider entity, or an indication to provide load analytics information comprising of statistical and predictive analytics data of at least one discovered AS. In an embodiment herein, the at least one AS discovery request may include other AS parameters, such as without limitation, time duration of the analytics data, and so on.

In an embodiment herein, the at least one analytics consumer entity (102) may be a user equipment having a unique subscription identifier (SI) used by the at least one analytics provider entity (104) to authenticate the at least one analytics consumer entity (102).

At step 304, the method may comprise transmitting by the at least one first analytics provider entity (104) at least one response message corresponding to the at least one AS discovery request. The method may comprise carrying out by the at least one first analytics provider entity (104) discovery of one or more ASs through a discovery procedure (as described in 3GPP TS 23.558v18.3.0 ), based on the at least one AS discovery request. Further, the method comprises transmitting by the at least one first analytics provider entity (104) to the at least one analytics consumer entity (102) the one or more one or more ASs with respective load analytics information as discovered by the at least one first analytics provider entity (104). In an embodiment herein, the at least one first analytics provider entity (104) transmits a response message to the at least one analytics consumer entity (102), wherein the at least one response message comprises in the application discovery response, statistical and predictive analytics data for each discovered AS.

At step 306, the method may comprise selecting by the at least one analytics consumer entity (102) the at least one AS of interest from the one or more discovered ASs with load analytics information for each of the one or more discovered ASs. In an embodiment herein, the at least one AS of interest from the one or more ASs with load analytics information, can be selected by the at least one first analytics provider entity (104) and the selected the at least one AS of interest with load analytics information, from the as discovered the one or more ASs, can be transmitted to the at least one consumer entity (102). The selection of the at least one AS of interest is performed based on the at least one AS discovery request.

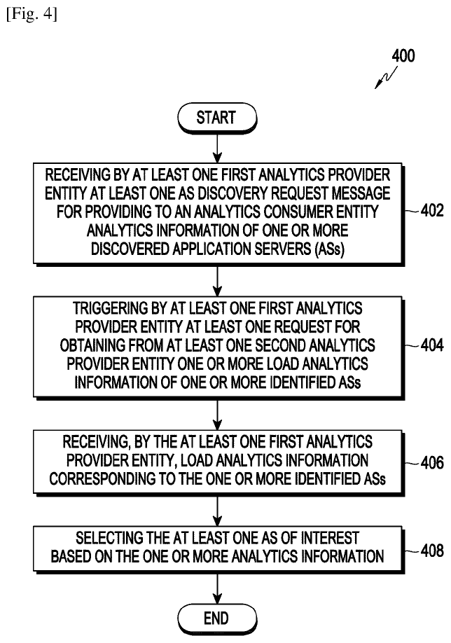

FIG. 4 depicts the method (400) for receiving by at least one first analytics provider entity (104) load analytics information of one or more ASs from at least one second analytics provider entity (106), according to various embodiments as disclosed herein.

Referring to FIG. 4, at step 402, the method may comprise receiving by the at least one first analytics provider entity (104) at least one AS discovery request message from at least one analytics consumer entity (102) with respect to providing load analytics information for at least one discovered Application server (AS). In an embodiment herein, the at least one discovered AS is at least one available Edge application server (EAS) having available services for the at least one analytics consumer entity, discovered in an Edge data network (EDN). In an embodiment, the request message may comprise at least one of a query for at least one available AS, an identity of the at least one analytics consumer entity (102), security credential(s) for authorization and verification of the at least one analytics consumer entity (102) by the at least one analytics provider entity, or an indication to provide load analytics information comprising of statistical and predictive analytics data of at least one discovered AS.

In an embodiment herein, the at least one first analytics provider entity (102) may perform a server discovery procedure for discovery of one or more available ASs (as described in 3GPP TS 23.558v18.3.0 ) to list out one or more ASs as identified ASs based on the at least one AS discovery request message.

At step 404, the method may comprise triggering by the at least one first analytics provider entity (104) at least one request message for obtaining from at least one second analytics provider entity (106) load analytics information for the one or more identified ASs, with respect to the at least one AS discovery request message the at least one first analytics provider entity (104) is received from the at least one analytics consumer entity (102). In an embodiment herein, the at least one request message for receiving from the at least one second analytics provider entity (106), load analytics information of the one or more ASs, is generated by the at least one first analytics provider entity (104), when the at least one first analytics provider entity (104) can't provide to the at least one analytics consumer entity (102), at least one AS with load analytics information, based on the at least one AS discovery request.

In an embodiment herein, the request message as transmitted by the least one first analytics provider entity (104) to the at least one second analytics provider entity (106), may comprise at least one of an identifier of the at least one first analytics provider entity (104), location of the at least one analytics consumer entity (102), mobile network operator (MNO) information which is serving the at least one analytics consumer entity (102), identity of the one or more identified AS for which the one or more analytics information is requested, type (statistical and/or predictive) of the one or more analytics information, or time duration since when analytics data is required a prediction expiration time for the at least one analytics consumer entity to reach a service area of the at least one AS.

In an embodiment, the at least one second analytics provider entity (106) may enable authorization of the at least one first analytics provider entity (104) to provide with one or more analytics information for the one or more ASs. In an embodiment, the authorization of the at least one first analytics provider entity (104) by the at least one second analytics provider entity (106) is carried out by transmitting an analytics response message to the at least one first analytics provider entity (104), corresponding to an analytics request from the at least one first analytics provider entity (104).

The method for obtaining analytics information by the at least one second analytics provider entity (106) is described 3GPP TS 23.436(v0.4.0 ). In order to facilitate derivation of analytics information corresponding to the request for receiving load analytics information for the one or more ASs, the at least one second analytics provider entity (106) can map an analytics event ID (e.g such as identification of the analytics data collected by the ADAES) as transmitted with the request to a list of analytics information collection event Identifiers and/or a list of AS provider Identifiers.

In an embodiment herein, the at least one second analytics provider (106) may transmit a subscription request to one or more AS providers, wherein the subscription request includes the list of analytics information collection event Identifiers and the requirement for data collection. The at least one second analytics provider entity (106) may receive load analytics information regarding one or more ASs from the at least one AS provider, based on the at least one subscription request as transmitted by the at least one second analytics provider entity to the one or more AS providers.

In an embodiment herein, such load analytics information may comprise without limitation, at least one of load analytics information about the load in terms of number of Edge application server (EAS) or Edge enabler server (EES) connections for a given area or time window, or the average edge computational resource usage or usage ratio based on an edge data network (EDN) total resource availability, EDN overload/high load indication events, or probability of AS unavailability due to high load. In an embodiment herein, based on the one or more AS provider, the one or more analytics information, as transmitted to the at least one second analytics provider entity may comprise without limitation, at least one of Per Edge application server/Edge enabler server (EAS/EES) computational resource load, number of connections per EES/EAS, N6 load, Data network (DN) performance analytics, or UPF load analytics (per DNAI, load for all cells within EDN coverage.

The load analytics information corresponding to the one or more discovered ASs is transmitted to the at least one first analytics server in a response message from the at least one second analytics provider entity. In an embodiment, if the partial analytics data is available; i.e., analytics data is not available for all identified ASs, then the at least one second analytics provider entity (106) adds the partial available analytics data in the response message.

At step 406, the method may comprise receiving, by the at least one first analytics provider entity, from the at least one second analytics provider entity (106), load analytics information corresponding to the one or more identified ASs.

At step 408, the method may comprise selecting by the at least one first analytics provider entity (104), at least one AS of interest from the received the one or more identified ASs with load analytics information, based on the at least one AS discovery request message as received by the at least one first analytics provider entity (104) from the at least one analytics consumer entity (102). The selected at least one AS of interest with load analytics information is communicated by the at least one first analytics provider entity (104) to the at least one analytics consumer entity (102).

In an embodiment herein, selecting at least one AS of interest is accomplished by the at least one analytics consumer entity (102), wherein the at least one analytics consumer entity (102) receives the one or more discovered ASs with respective analytics information from the at least one first analytics provider entity (104), wherein the load analytics information are provided by the at least one second analytics provider entity (106), to the at least one first analytics provider entity (104).

In an embodiment herein, if the first analytics provider entity (104) does not have the required analytics data of the application server(s) identified by the at least one first analytics provider entity (104) based on the at least one AS discovery request message form the at least one analytics consumer entity (102), the server may request the at least one second analytics provider entity (106) (e.g. the ADAE server) to provide the load analytics information of the one or more ASs. In an embodiment herein, the first analytics provider entity (104) includes statistical and predictive analytics data for each of the discovered AS in the application discovery response. In an embodiment, if the partial analytics data is available; i.e., analytics data is not available for all discovered ASs, the at least one first analytics provider entity (104) adds the partial available analytics data in the response.

In an embodiment herein, the at least one first analytics provider entity (104) may send the statistical and predictive analytics data of the discovered ASs in the application discovery response without any indication for requesting analytics information for at least one AS with the at least one AS discovery message request from the at least one analytics consumer entity (102).

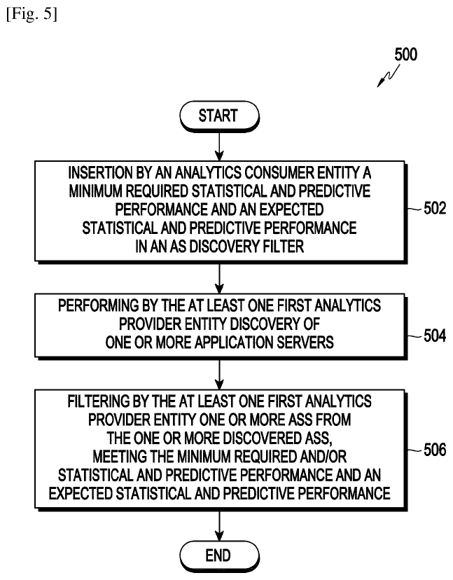

FIG. 5 depicts the method (500) for providing by the at least one analytics consumer entity (102) one or more discovery filters in the at least one AS discovery request, for the at least one first analytics provider entity, according to various embodiments as disclosed herein.

Referring FIG. 5, at step 502, the method may comprise insertion by the at least one analytics consumer entity (102), in at least one filtered AS discovery request message, at least one minimum required analytics information in the application discovery request and/or at least one expected analytics information. In an embodiment herein, the minimum required analytics information could be, such as without limitation, minimum performance information of an AS based on analytics information. Further, in an embodiment herein, the expected analytics information could be, for example, the expected performance information of an AS based on analytics information.

The at least one filtered AS discovery request message may comprise at least one of a query for at least one available AS, an identity of the at least one analytics consumer entity (102), security credential(s) for authorization and verification of the at least one analytics consumer entity (102) by the at least one first analytics provider entity (104), or an indication to provide load analytics information comprising of statistical and predictive analytics data of at least one discovered AS.

At step 504, the method may comprise, performing by the at least one first analytics provider entity (104) an AS discovery procedure (as described in 3GPP TS 23.558 v18.3.0) to list out one or more available ASs meeting the at least one filtered AS discovery request.

At step 506, the method may comprise filtering by the at least one first analytics provider entity (104), one or more ASs from the one or more discovered ASs, meeting the minimum required and/or statistical and predictive performance and an expected statistical and predictive performance. The at least one first analytics provider entity (104), therefore identifies and filters the application server matching the minimum required or expected analytics data and includes one or more filtered ASs in the discovery response.

The method may comprise transmitting by the at least one first analytics provider entity (104), at least one response message comprising one or more filtered ASs having one or more load analytics information as obtained from the one or more discovered ASs. In an embodiment, if the at least one first analytics provider entity (104) does not have the required analytics data of the one or more filtered ASs, the at least one first analytics provider entity (104) can request at least one second analytics provider entity (106) (like the ADAE server) to provide the required analytics data (as described for FIG. 4) of the one or more filtered ASs.

Embodiments herein disclose a procedure for clients to request on-demand statistical and predictive analytics data of the application server(s) from the analytics server. The at least one analytics consumer entity (102) may send an indication to the at least one analytics provider entity (104) to include analytics data in the application discovery response. The at least one analytics provider entity (104) can send the analytics data of one or more requested application server in the application discovery response. The at least one analytics consumer entity (102) may send one or more discovery filters indicating minimum required analytics data to the server entity. The at least one analytics consumer entity (102) may further send discovery filters indicating expected analytics data to the at least one analytics provider entity (104). The at least one analytics provider entity (104) can discover the application servers matching the discovery filters based on the received analytics data.

The embodiments disclosed herein can be implemented through at least one software program running on at least one hardware device and performing network management functions to control the elements. The elements can be at least one of a hardware device, or a combination of hardware device and software module.

Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device.

The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

1. A method performed by an analytics consumer entity for requesting analytics data in a wireless communication network, the method comprising:
transmitting, to a first analytics provider entity, a discovery request message including information to be used to get load analytics information from at least one application data analytics enabler (ADAE) server; and
receiving, from the first analytics provider entity, a discovery response message corresponding to the discovery request message, wherein the discovery response message includes information on one or more discovered application server (AS) entities and analytics information corresponding to the one or more discovered AS entities.

2. The method of claim 1, further comprising:
selecting at least one AS entity of interest from the information on the one or more discovered AS entities, based on the analytics information.

3. The method of claim 2, wherein selecting the at least one AS entity of interest comprises:
mapping, the information on the one or more discovered AS entities and the analytics information, with the information to be used to get the load analytics information corresponding to the at least one AS entity of interest.

4. The method of claim 1, wherein the discovery request message includes at least one of an identifier of the analytics consumer entity, or at least one security credential for authorization and verification of the analytics consumer entity.

5. The method of claim 1, wherein the analytics information includes statistical analytics data and predictive analytics data for each of the one or more discovered AS entities.

6. The method of claim 1, wherein the analytics information corresponding to the one or more discovered AS entities, includes at least one of:
a number of available ASs to connect for a given area or time window, edge computational resource usage data, a number of times the analytics consumer entity has received expected performance from the first analytics provider entity, Edge data network (EDN) high load indication events, or probability of unavailability of the one or more discovered AS entities, due to high load.

7. The method of claim 1, wherein the discovery request message includes at least one filtered AS discovery request including an indication of minimum required load analytics data and expected load analytics data, and
wherein the discovery response message corresponds to the filtered AS discovery request.

8. A method performed by a first analytics provider entity for requesting analytics data in a wireless communication network, the method comprising:
receiving, from an analytics consumer entity, a discovery request message to discover at least one application server (AS) entity, wherein the discovery request message includes information to be used to get load analytics information from at least one application data analytics enabler (ADAE) server;
transmitting, to a second analytics provider entity, an analytics data request message to get analytics data for one or more discovered application server (AS) entities, identified by the first analytics provider entity based on the discovery request message of the analytics consumer entity;
receiving, from the second analytics provider entity, an analytics data response message including analytics information corresponding to the one or more discovered AS entities; and
transmitting a discovery response message including information on the one or more discovered AS entities and the analytics information corresponding to the one or more discovered AS entities.

9. The method of claim 8, further comprising:
selecting at least one AS entity of interest from the one or more discovered AS entities, based on the analytics information corresponding to the one or more discovered AS entities,
wherein the first analytics provider entity is authenticated by the second analytics provider entity using an identifier of the first analytics provider entity.

10. The method of claim 8, wherein the analytics data request message is received by the first analytics provider entity, wherein the first analytics provider entity is a first edge enabler server entity in an edge data network; and
wherein the analytics data request message is received by the second analytics provider entity in communication with the first analytics provider entity, wherein the second analytics provider entity provides the analytics data response message corresponding to the discovery request message to the first analytics provider entity.

11. The method of claim 8, wherein the analytics data request message includes at least one of:
an identifier of the first analytics provider entity, at least one security credential for authorization and verification of the first analytics provider entity, one or more identifiers of the one or more discovered AS entities, statistical and predictive data of the analytics information, time duration since when the analytics information is required, or location information on the analytics consumer entity.

12. The method of claim 8, further comprising:
authenticating the analytics consumer entity, using an identifier of the analytics consumer entity.

13. An analytics consumer entity comprising:
a processor; and
memory communicably coupled with the processor, wherein the processor is configured to:
transmit, to a first analytics provider entity, a discovery request message including information to be used to get load analytics information from at least one application data analytics enabler (ADAE) server; and
receive, from the first analytics provider entity, a discovery response message corresponding to the discovery request message, wherein the discovery response message includes information on one or more discovered application server (AS) entities and analytics information corresponding to the one or more discovered AS entities.

14. The analytics consumer entity of claim 13, wherein the discovery request message includes at least one of an identifier of the analytics consumer entity, or at least one security credential for authorization and verification of the analytics consumer entity, and
wherein the analytics information includes statistical analytics data and predictive analytics data for each of the one or more discovered AS entities.

15. A first analytics provider entity for requesting analytics data in a wireless communication network, the first analytics provider entity comprising:
a processor; and
memory communicably coupled with the processor, wherein the processor is configured to:
receive, from an analytics consumer entity, a discovery request message to discover at least one application server (AS) entity, wherein the discovery request message includes information to be used to get load analytics information from at least one application data analytics enabler (ADAE) server;
transmit, to a second analytics provider entity, an analytics data request message to get analytics data for one or more discovered application server (AS) entities, identified by the first analytics provider entity, based on the discovery request message of the analytics consumer entity;
receive, from the second analytics provider entity, an analytics data response message including analytics information corresponding to the one or more discovered AS entities; and
transmit, to the analytics consumer entity, a discovery response message including information on the one or more discovered AS entities and the analytics information corresponding to the one or more discovered AS entities.

16. The analytics consumer entity of claim 13, wherein the processor is further configured to:
select at least one AS entity of interest from the information on the one or more discovered AS entities, based on the analytics information.

17. The analytics consumer entity of claim 16, wherein the processor is further configured to:
map the information on the one or more discovered AS entities and the analytics information, with the information to be used to get the load analytics information corresponding to the at least one AS entity of interest.

18. The analytics consumer entity of claim 13, wherein the analytics information includes statistical analytics data and predictive analytics data for each of the one or more discovered AS entities.

19. The analytics consumer entity of claim 13, wherein the analytics information corresponding to the one or more discovered AS entities, includes at least one of: a number of available ASs to connect for a given area or time window, edge computational resource usage data, a number of times the analytics consumer entity has received expected performance from the first analytics provider entity, Edge data network (EDN) high load indication events, or probability of unavailability of the one or more discovered AS entities, due to high load.

20. The analytics consumer entity of claim 13, wherein the discovery request message includes at least one filtered AS discovery request including an indication of minimum required load analytics data, and an expected load analytics data, and
wherein the discovery response message corresponds to the filtered AS discovery request.
